(19) United States
(12) Patent Application Publication
(10) Pub. No.: US 2016/0005237 A1
(43) Pub. Date: Jan. 7, 2016

(54) METHOD AND SYSTEM FOR AUTOMATICALLY ALIGNING MODELS OF AN UPPER JAW AND A LOWER JAW

(71) Applicant: CARESTREAM HEALTH, INC., Rochester, NY (US)

(72) Inventors: Qinran Chen, Shanghai (CN); Weifeng Gu, Shanghai (CN); Yannick Glinec, Shanghai (CN)

(21) Appl. No.: 14/768,636

(22) PCT Filed: Mar. 11, 2013
(86) PCT No.: PCT/CN2013/072391

§ 371 Date: Aug. 18, 2015

(51) Int. Cl. G06T 19/20; G06T 3/00; G06T 15/00; G06K 9/62; A61C 9/00; G06T 7/00

(52) U.S. Cl. CPC G06T 19/20; A61C 9/0053; G06T 7/0014; G06T 15/005; G06K 9/6201; G06T 3/00; G06T 2207/30036; G06T 2219/2004

(57) ABSTRACT

A method for automatically aligning a model for an upper jaw with a model for a lower jaw, the method including forming models for teeth of the upper jaw and the lower jaw based on images; obtaining a reference bite frame with the teeth in a clenched state; aligning the models for the teeth of the upper jaw and the lower jaw with the reference bite frame, respectively, to determine transform information between the generated models and the reference bite frame; aligning the model for the teeth of the upper jaw with that of the lower jaw based on the determined transform information.

### TECHNICAL FIELD

The present application generally relates to a method and system for aligning of objects, particularly relates to the aligning of the upper jaw and the lower jaw.

### BACKGROUND

Traditionally, impressions are taken by using a putty-based material in order to make a mould of the patient's teeth. Such process is extremely uncomfortable and messy for patients.

With the development of the computer-aided design and computer-aided manufacturing, the digitized three-dimensional technology is well used in the process of the intraoral examination and the like, in place of forming the mould of the patient's teeth with putty-based material.

The conventional technology used for example in the intraoral examination requires aligning the digitized three-dimensional model of the upper jaw with that of the lower jaw manually. Thus, the time on examination and the complexity of align are relative large for users.

There is a need for the solution speeding up for example the operation of dentist in examination of the teeth of the patient and reducing the complexity for users.

### SUMMARY

According to one aspect of the present invention, there is provided a method for automatically aligning a model for an upper jaw with a model for a lower jaw. The method can include:

a. forming a model for teeth of the upper j aw based on respective images;

b. forming a model for teeth of the lower j aw based on respective images;

c. obtaining a reference bite frame with the teeth of the upper jaw and lower jaw in a clenched state;

d. aligning the model for the teeth of the upper jaw and the model for the teeth of the lower jaw with the reference bite frame, respectively, to determine transform information between the generated models and the reference bite frame;

e. aligning the model for the teeth of the upper jaw with the model for the teeth of the lower jaw based on the determined transform information.

According to another aspect of the present application, there is provided a system for automatically aligning a model for an upper jaw with a model for a lower jaw. The system includes a model forming module, an obtaining module, a first process module, and a second process module.

The model forming module can be used for forming a model for teeth of the upper jaw based on respective images and forming a model for teeth of the lower jaw based on respective images. The obtaining module can be used for obtaining a reference bite frame with the teeth of the upper jaw and the lower jaw in a clenched state. The first process module can be used for aligning the model for the teeth of the upper jaw and the model for the teeth of the lower jaw with the reference bite frame, respectively, and used for determining transform information between the models and the reference bite frame. The second process module can be used for aligning the model for the teeth of the upper jaw with the model for the teeth of the lower jaw based on the determined transform information.

The method according to an embodiment of the present application can align the model for the teeth of the upper jaw with the model for the teeth of the lower jaw automatically.

### BRIEF DESCRIPTION OF THE DRAWINGS

The forgoing and other objects, features, and advantages of the invention will be apparent from the following more particular description of the embodiments of the invention, as illustrated in the accompanying drawings. The elements of the drawings are not necessary to scale relative to each other.

FIG. 1 is a flowchart of the conventional method for bite registration.

FIG. 2 is a flowchart of the method for automatically aligning a model for an upper jaw with a model for a lower jaw according to an embodiment of the present application.

FIG. 3a illustrates a block diagram of an architecture which can apply the method shown in FIG. 2.

FIG. 3b illustrates a block diagram of a particular apparatus which can apply the method shown in FIG. 2.

FIGS. 4a-4h show one 3D surface of the teeth and FIG. 4i shows a model stitched from these surfaces.

FIG. 5a shows the generated model for the teeth of the upper jaw, which can be formed through steps 40 and 41 according to the method shown in FIG. 2.

FIG. 5b illustrates the generated model for the teeth of the lower jaw, which can be formed through steps 42 and 43 according to the method shown in FIG. 2.

FIG. 5C shows the reference bite frame, which can be obtained at step 44 according to the method shown in FIG. 2.

FIG. 5d shows, in a manner that the model for the teeth of the upper jaw in FIG. 5a and the model for the teeth of the lower jaw in FIG. 5b in teeth clenched state, the aligned models.

FIG. 6 shows a block diagram of a system for automatically aligning a model for an upper jaw with a model for a lower jaw.

### DETAILED DESCRIPTION

The following is a detailed description of the preferred embodiments of the invention, reference being made to the drawings in which the same reference numerals identify the same elements of structure in each of the several figures. Whereby they are used, the terms “first”, “second”, and so on, do not necessarily denote any ordinal, sequential, or priority relation, but are simply used to more clearly distinguish one element or set of elements from another.

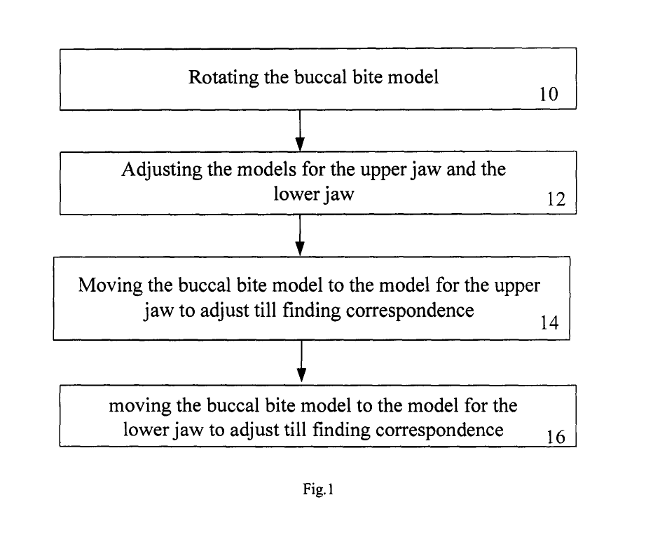

FIG. 1 is a flowchart of the conventional method for bite registration. In performing the method shown in FIG. 1, models of an upper jaw and a lower jaw have been created. Further, a buccal bite model has also been obtained. These models are shown to the operator, such as the dentist, for example on a display of a computer. The dentist further performs the method shown in FIG. 1 to align the model for the upper jaw with the model for the lower jaw manually.

As shown, in step 10, the buccal bite model is rotated such that the overlap of the teeth of the upper jaw and the teeth of the lower jaw in this model can be seen. In step 12, the model for an upper jaw and model for a lower jaw are adjusted by rotation such that they are visually aligned each other. Then, in step 14, the buccal bite model which has been rotated as the step 10 is moved to the model for the upper jaw and adjusted till the buccal bite model finds its correspondence in the model for the upper jaw. In step 16, the buccal bite model which has been rotated as the step 10 is moved to the model for the lower jaw and adjusted till the buccal bite model finds its correspondence in the model for the lower jaw. Then, according to the alignments at step 14 and 12, the model for the upper jaw can be aligned with the model for the lower jaw. As mentioned before, the steps shown in FIG. 1 are performed by the operator for example by operating the examination machine through a mouse.

If a dentist intends to insert prosthetic into the soft or bony tissue of a patient, then he has to first obtain a complete teeth model where the teeth of the upper jaw are aligned with the teeth of the lower jaw. According to the conventional method shown in FIG. 1, the dentist has to align the model with the model through the steps 10-16 manually, which prolongs the time period of the examination and increases his workload.

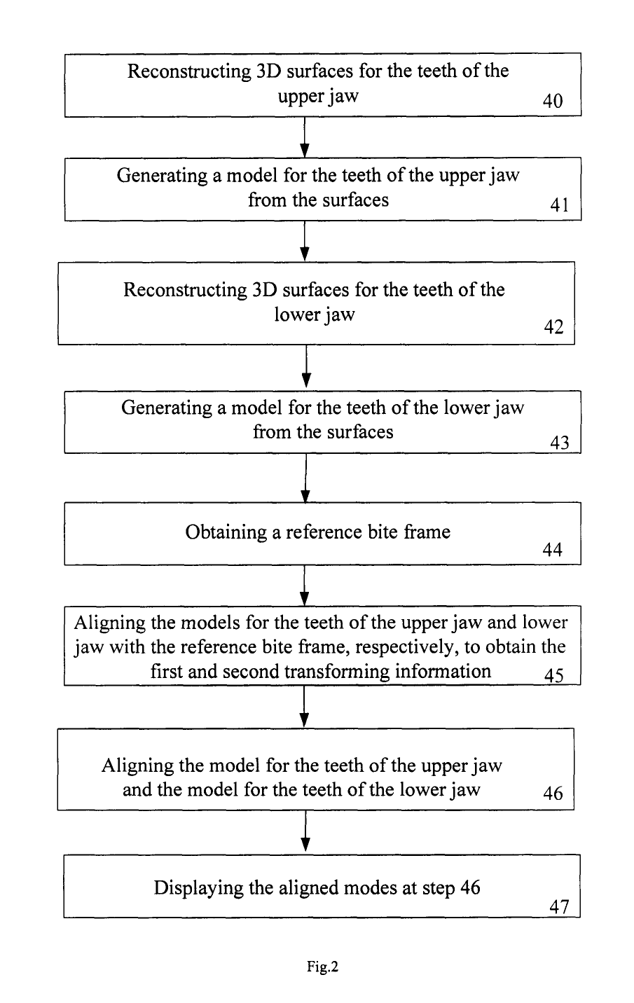

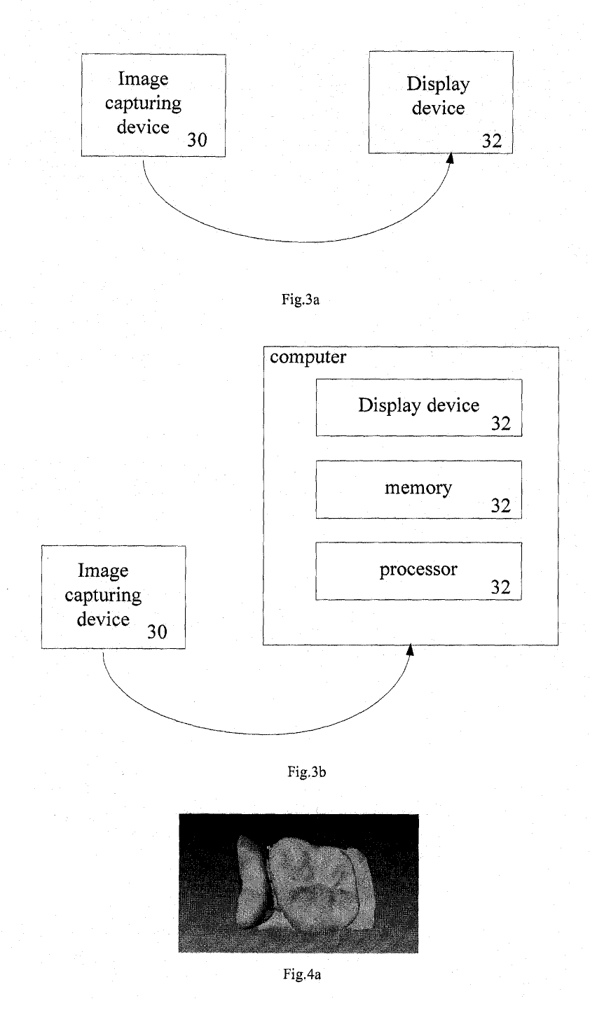

FIG. 2 is a flowchart of the method for automatically aligning a model for an upper jaw with a model for a lower jaw according to an embodiment of the present application. The method shown in FIG. 3 can be applied to the architecture such as shown in FIG. 3a. The architecture in FIG. 3a includes an image capturing device 30, such as a scanner, and a display device 32 coupled to the device 30. The image capturing device 30 can be used to scan the teeth at various view angles in the oral cavity. The display device 32 is used to display the images captured by the image capturing device 30 or created by a processor based on the images captured by the image capturing device, where the processor can be provided in the image capturing device 32, integrated with the display device 32, or separately provided in said architecture. Preferably, the apparatus can include a memory to store the image data obtained by the image capturing device and/or the image data from the processor if any.

FIG. 3b shows a block diagram of an example of a particular apparatus employing the method shown in FIG. 2. The apparatus in FIG. 3b includes the image capturing device 30 and a computer including a processor 31, the display device 32, and a memory 33, where the computer can be used in the medical image processing. The image capturing device 30 is coupled to the computer.

By an illustrative example not limiting, the method shown in FIG. 2 will be discussed in combination with the apparatus in FIG. 3b hereinafter. In step 40, three dimensional (3D) surfaces for teeth of the upper jaw from respective images are reconstructed. The respective images, i.e., images for the upper jaw at this step, generally are two dimensional (2D) for example captured by the image capturing device 30. The obtained image data is transferred to the processor 31 for reconstructing 3D surfaces for the teeth of the upper jaw. The processor 31 reconstructs 3D surfaces for the teeth of the upper jaw with the known technical means in the art.

As known, an individual tooth surface is reconstructed from a set of images captured at the same view angle, where the set of images can include only one image or include more than one image. Accordingly, a plurality of sets of images shall be captured for forming a plurality of tooth surfaces, where each set of images is captured at the same view angle and the different set of images are captured from different view angle. Therefore, in step 40, in order to forming a plurality of tooth surfaces for teeth of the upper jaw, a plurality of sets of images for the teeth of upper jaw shall be obtained.

In step 41, a model for the teeth of the upper jaw is generated from the reconstructed 3D surfaces for the teeth of the upper jaw. For example, the processor 31 can generate the model for the teeth of the upper jaw by stitching these reconstructed 3D tooth surfaces.

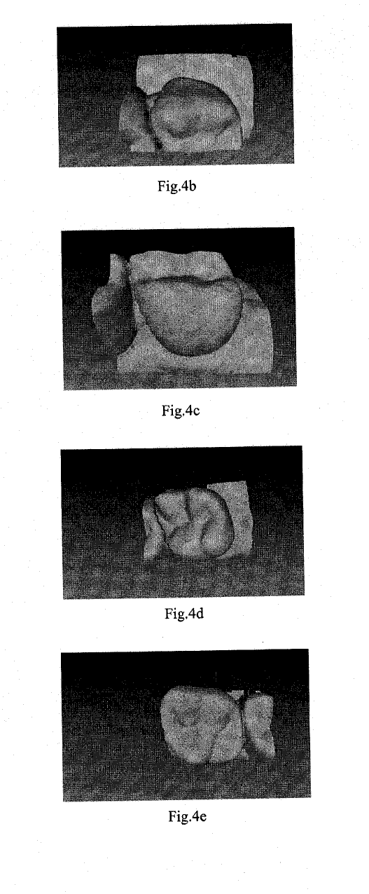

Each of the FIGS. 4a-4h show one 3D surface of the teeth and FIG. 4i shows a model stitched from these surfaces. Here, FIGS. 4a-4i are only used to show the process of the forming of a model from several 3D surfaces. It can be understand that these teeth shown in FIGS. 4a-4i are not used to limit the surfaces and models in all examples of the present application.

In step 42, three dimensional (3D) surfaces for teeth of the lower jaw from respective images are reconstructed. The respective images, i.e., images for the lower jaw at this step, generally are two dimensional images for example captured by the image capturing device 30. The obtained image data is transferred to the processor 31 for reconstructing 3D surfaces for the teeth of the upper jaw. The processor 31 reconstructs the 3D surfaces for the teeth of the lower jaw in the same manner as reconstructs the 3D surfaces for the teeth of the upper jaw.

In step 43, a model for the teeth of the lower jaw is generated from the reconstructed 3D surfaces for the teeth of the lower jaw. For example, the processor 31 can generate the model for the teeth of the lower jaw by stitching these reconstructed surfaces for the lower jaw.

In step 44, a reference bite frame is obtained with the teeth of the upper jaw and the lower jaw in a clenched state. By an example, the image capturing device 30 only scans a part of all clenched teeth and then transmits the captured images data to the processor 32. The processor 32 reconstructs 3D surfaces for that part of the teeth, and generates 3D model as the reference bite frame.

By example, the reference bite frame can be formed based on a set of images, where this set of images is for example captured by the image capturing device 30 at the same view angle. That is, only one surface is formed for the reference bite frame or this surface is used as the reference bite frame. Alternatively, the bite frame is formed in the similar way as above described with respect to the model for the teeth of the upper jaw.

In step 45, the generated model for the teeth of the upper jaw is aligned with the reference bite frame and the generated model for the teeth of the lower jaw is aligned with the reference bite frame, and thus the transform information between the generated models and the reference bite frame is determined.

By an illustrative example, the correspondence that the reference bite frame corresponds to the model for the teeth of upper jaw is detected for example based on features, and the correspondence that the reference bite frame corresponds to the model for the teeth of lower jaw is also detected for example based on features. Then the first transform information between the generated model for the teeth of the upper jaw and the reference bite frame and the second transform information between the generated model for the teeth of the lower jaw and the reference bite frame are calculated, respectively, based on the respective detected correspondence.

Alternatively, anyone of the reconstructed 3D surfaces for the teeth of the upper jaw is aligned with the reference bite frame so as to determine upper transform information, which indicates the transform relationship between said one of the reconstructed 3D surfaces and the reference bite frame. Then on the basis of the upper transform information and the relationship between the model for the teeth of upper jaw and said one of the three dimension surfaces for the teeth of the upper jaw, which is determined in forming the 3D model for the teeth of upper jaw, a first transform information can be calculated. Similarly, the second transform information can be obtained based on the lower transform information between any one of the 3D surfaces for the teeth of lower jaw and the reference bite frame and the relationship between the model for the teeth of lower jaw and said one of 3D surfaces for the teeth of lower jaw.

Furthermore, the alignment of any one of the reconstructed 3D surfaces for the teeth of the upper jaw with the reference bite frame can be performed by detecting, on the features, the correspondence between them. The alignment of any one of the reconstructed 3D surfaces for the teeth of the lower jaw with the reference bite frame can be performed by detecting, on the features, the correspondence between them.

In step 46, the generated model for the teeth of the upper jaw is automatically aligned with the generated model for the teeth of the lower jaw based on the determined first and second transform information.

Optionally, the aligned models for the teeth of the upper jaw and the lower jaw are displayed in the displaying device 32. Preferably, the aligned models of the teeth of the upper jaw and the lower jaw are displayed in a manner of the teeth of the models in a clenched state.

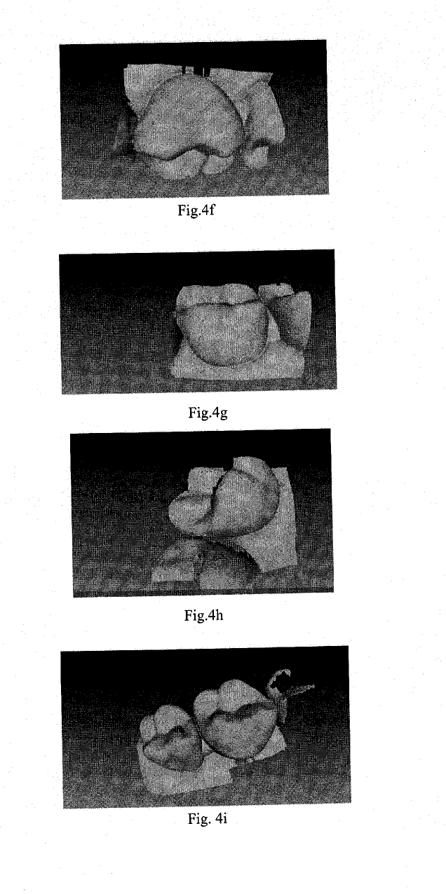

By an example, FIG. 5a shows the generated model for the teeth of the upper jaw, which can be formed through steps 40 and 41. FIG. 5b illustrates the generated model for the teeth of the lower jaw, which can be formed through steps 42 and 43. FIG. 5C shows the reference bite frame, which can be obtained at step 44. And FIG. 5d shows, in a manner that the model for the teeth of the upper jaw and the model for the teeth of the lower jaw in teeth clenched state, the aligned models.

With the method shown in FIG. 2 being applied to the architecture or apparatus used to examining the teeth, such as that shown in FIGS. 3a and 3b, the models for the teeth of the upper jaw and the teeth of the lower jaw can be aligned automatically and if desired, can be displayed without any manual operation from the operator. Therefore, the examination time on the teeth is reduced and the workload of the dentist is decreased, for example. Furthermore, the complexity of alignment for the users is substantially eliminated due to no manual alignment.

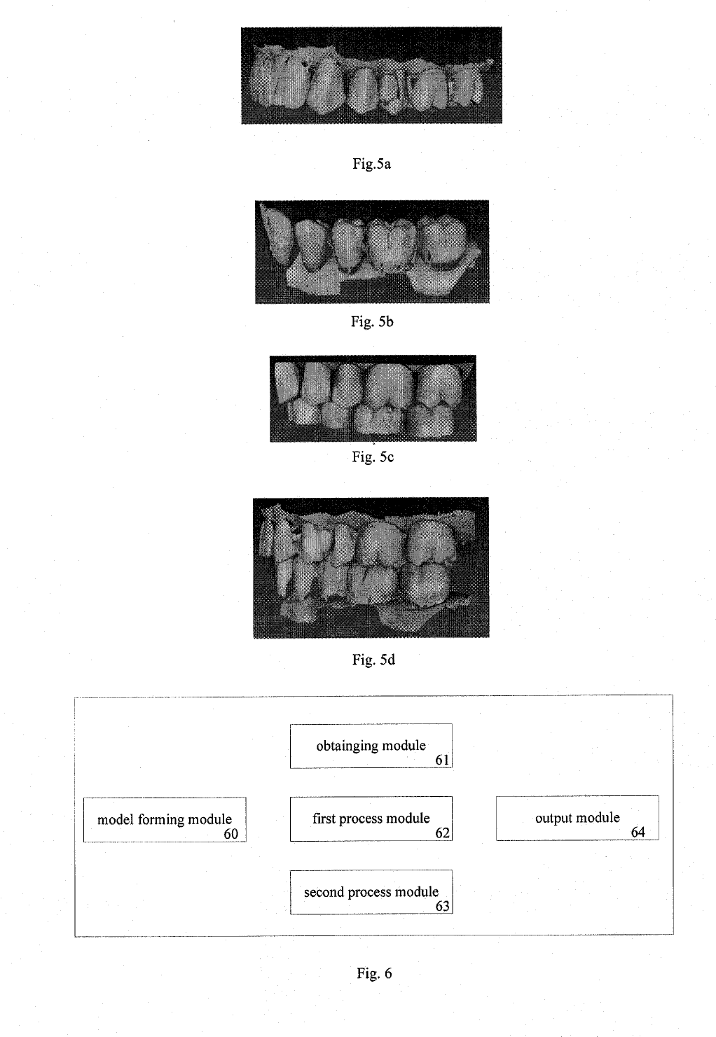

FIG. 6 shows a block diagram of a system for automatically aligning a model for an upper jaw with a model for a lower jaw. The system can be employed by an architecture shown in FIG. 3a. And particularly, the system shown in FIG. 6 can be applied to the apparatus shown in FIG. 3b. The system includes a model forming module 60, an obtaining module 61, a first process module 62, a second process module 63, and optionally include an output module 64.

Referring to FIGS. 6 and 3a, the model forming module 60 forms a model for the teeth of the upper jaw based on images of the upper jaw captured by the image capturing device 30 and forms a model for the teeth of the lower jaw based on images of the lower jaw captured by the image capturing device 30. By an example, the model forming module 60 includes a reconstructing sub-module and a generating sub-module. The reconstructing sub-module reconstructs 3D surfaces for the teeth of the upper jaw from two dimensional images for the upper jaw, and reconstructs 3D surfaces for the teeth of the lower jaw from two dimensional images for that jaw. The generating sub-module generates the model for the teeth of the upper jaw from the reconstructed 3D surfaces for the teeth of the upper jaw, and generates the model for the teeth of the lower jaw from the reconstructed 3D surfaces for the teeth of the lower jaw.

The obtaining module 61 obtains a reference bite frame with the teeth of the upper jaw and the lower jaw in a clenched state. By an illustrative example not limiting, the obtaining module 61 obtains the reference bite frame with the teeth in a clenched state by reconstructing 3D surface (s) for a part of all clenched teeth based on the 2D image (s) for example captured by the image capturing device 30 and generating the reference bite frame on the reconstructed three dimension surfaces. The reference bite frame can be formed as above described with respect to the method shown in FIG. 2.

The first process module 62 aligns the model for the teeth of the upper jaw and the model for the teeth of the lower jaw with the reference bite frame, respectively, and determines transform information between the models and the reference bite frame.

By an example, the first process module 62 aligns the model for the teeth of the upper jaw with the reference bite image by detecting the correspondence between the model for the teeth of the upper jaw and the reference bite frame and then determining a first transform information between the generated model for the teeth of the upper jaw and the reference bite frame based on the detected correspondence. Also, the first process module 61 aligns the model for the teeth of the lower jaw with the reference bite frame by detecting the correspondence between the model for the teeth of the lower jaw and the reference bite image, and determining a second transform information between the generated model for the teeth of the lower jaw and the reference bite frame based on the detected correspondence.

Alternatively, the first process module 62 aligns any one of the reconstructed 3D surfaces for the teeth of the upper jaw with the reference bite frame so as to determine upper transform information, which indicates the transforming relationship between said one of the reconstructed 3D surfaces and the reference bite frame. Then on the basis of the upper transform information and the relationship between the model for the teeth of upper jaw and said one of the three dimension surfaces for the teeth of the upper jaw, which is determined in forming the 3D model for the teeth of upper jaw, the first process module 62 determines the first transform information. The first process module 62 also determines the second transform information in a similar way as determines the first transform information. The first process module 62 aligns said one of the 3D surfaces for the teeth of the upper jaw with the reference bite frame for example by detecting, for example on the basis of features, the correspondence between said one of the 3D surfaces for the teeth of the upper jaw and the reference bite frame, and aligns said one of the 3D surfaces for the teeth of the lower jaw with the reference bite frame for example by detecting, for example on the basis of features, the correspondence between said one of the 3D surfaces for the teeth of the lower jaw and the reference bite frame.

The second process module 63 automatically aligns the model for the teeth of the upper jaw with the model for the teeth of the lower jaw based on the determined first and second transform information. If the output module 64 is included by the system shown in FIG. 6, upon the second process module 63 aligns the models for the upper jaw with the lower jaw, the output module 64 outputs the aligned model for the teeth of the upper jaw and the model for the teeth of the lower jaw to the display device 32 for displaying the aligned models, as shown in FIG. 5c. Preferably, the output module 64 also outputs the formed model for the teeth of the upper jaw, as shown in FIG. 5a, and the formed model for the teeth of the lower jaw, as shown in FIG. 5b to the display device 32 for displaying, respective.

The term of the model for the lower jaw herein refers to the model for the teeth of the lower jaw, and the term of the model for the upper jaw herein refers to the model for the teeth of the lower jaw.

Each of the module or sub-modules included by the system shown in FIG. 6 can be embodies as software or hardware or their combination. The obtaining module 61, the first process module 62, and the second process module 63 can be integrated into one processor, for example the processor of the apparatus shown in FIG. 3b.

With the system shown in FIG. 6 being employed in the architecture or apparatus for examining the teeth, the models for the teeth of the upper jaw and the teeth of the lower jaw can be aligned automatically and displayed without any manual operation from the operator. Therefore, the examination time on the teeth is reduced and the workload of the dentist is also decreased, for example.

Although illustrative embodiments of the invention have been described in detail herein with reference to the accompanying drawings, it is to be understood that the invention is not limited to those particular embodiments, and that various changes and modifications can be effected therein by one skilled in the art without departing from the scope and spirit of the invention as defined by the appended claims.

1. A method for automatically aligning a model for an upper jaw with a model for a lower jaw, including:
a. forming a model for teeth of the upper jaw based on respective images;
b. forming a model for teeth of the lower jaw based on respective images;
c. obtaining a reference bite frame with the teeth of the upper jaw and lower jaw in a clenched state;
d. aligning the model for the teeth of the upper jaw and the model for the teeth of the lower jaw with the reference bite frame, respectively, to determine transform information between the generated models and the reference bite frame;
e. aligning the model for the teeth of the upper jaw with the model for the teeth of the lower jaw based on the determined transform information.

2. The method of claim 1, wherein the step a includes
i. reconstructing three dimensional surfaces for the teeth of the upper jaw from the respective images;
ii. generating a model for the teeth of the upper jaw from the reconstructed three dimensional surfaces for the teeth of the upper jaw; and wherein the step b includes
iii. reconstructing three dimension surfaces for the teeth of the lower jaw from the respective images;
iv. generating a model for the teeth of the lower jaw from the reconstructed three dimensional surfaces for the teeth of the lower jaw.

3. The method of claim 1, wherein the step c includes:
capturing images for a part of all teeth;
reconstructing three dimension surf aces for said part of the teeth from the captured images;
generating the reference bite frame based on the reconstructed three dimensional surfaces.

4. The method of claim 1, wherein the step d includes:
aligning the model for the teeth of the upper jaw with the reference bite frame by detecting the correspondence between said model for the teeth of the upper jaw and the reference bite frame, and calculating a first transform information between the generated model for the teeth of the upper jaw and the reference bite image based on the detected correspondence; and
aligning the model for the teeth of the lower jaw with the reference bite frame by detecting the correspondence between the model for the teeth of the lower jaw and the reference bite frame, and calculating a second transform information between the generated model for the teeth of the lower jaw and the reference bite image based on the detected correspondence.

5. The method of claim 2, wherein the step d includes:
aligning the model for the teeth of the upper jaw with the reference bite frame by:
aligning one of the three dimensional surfaces for the teeth of the upper jaw with the reference bite frame to determine upper transform information between said one of the three dimensional surfaces for the teeth of the upper jaw and the reference bite frame,
calculating a first transform information between the model for the teeth of the upper jaw and the reference bite frame based on the upper transform information and relationship between the model for the teeth of the upper jaw and said one of the three dimension surfaces for the teeth of the upper jaw; and
aligning the model for the teeth of the lower jaw with the reference bite frame by:
aligning one of the three dimensional surfaces for the teeth of the lower jaw and the reference bite frame to determine lower transform information between said one of the three dimension surfaces for the teeth of the lower jaw and the reference bite frame,
calculating a second transform information between the model for the teeth of the lower jaw and the reference bite frame based on the lower transform information and relationship between the model for the teeth of the lower jaw and said one of the three dimensional surfaces for the teeth of the lower jaw.

6. The method of claim 5, wherein the aligning one of the three dimensional surfaces for the teeth of the upper jaw and the reference bite frame by detecting the correspondence between said one of the three dimension surfaces for the teeth of the upper jaw and the reference bite frame; and the aligning one of the three dimension surfaces for the teeth of the lower jaw and the reference bite frame by detecting the correspondence between said one of the three dimension surfaces for the teeth of the lower jaw and the reference bite frame.

7. The method of claim 4, wherein the step e includes matching the model for the teeth of the upper jaw with the model for the teeth of the lower jaw based on the first and second transform information.

8. A system for automatically aligning a model for an upper jaw with a model for a lower jaw, the system including:
a model forming module used for forming a model for teeth of the upper jaw based on respective images and forming a model for teeth of the lower jaw based on respective images;
an obtaining module used for obtaining a reference bite frame with the teeth of the upper jaw and the lower jaw in a clenched state;
a first process module used for aligning the model for the teeth of the upper jaw and the model for the teeth of the lower jaw with the reference bite frame, respectively, and used for determining transform information between the models and the reference bite frame;
a second process module used for aligning the model for the teeth of the upper jaw with the model for the teeth of the lower jaw based on the determined transform information.

9. The system of claim 8, wherein the model forming module includes:
a reconstructing sub-module used for reconstructing three dimensional surfaces for the teeth of the upper jaw from the respective images and reconstructing three dimensional surfaces for the teeth of the lower jaw from the respective images;
a generating sub-module used for generating the model for the teeth of the upper jaw from the reconstructed three dimensional surfaces for the teeth of the upper jaw and generating the model for the teeth of the lower jaw from the reconstructed three dimensional surfaces for the teeth of the lower jaw.

10. The system of claim 8, wherein the obtaining module is configured to obtain the reference bite frame with the teeth of the upper jaw and the lower jaw in a clenched state by:
reconstructing three dimensional surfaces for a part of all teeth based on the images captured with the teeth of the upper jaw and the lower jaw is in the clenched state; and
generating the reference bite frame on the reconstructed three dimensional surfaces.

11. The system of claim 8, wherein the first process module is configured for:
aligning the model for the teeth of the upper jaw with the reference bite image by detecting the correspondence between the model for the teeth of the upper jaw and the reference bite frame, and determining a first transform information between the generated model for the teeth of the upper jaw and the reference bite frame based on the detected correspondence; and
aligning the model for the teeth of the lower jaw with the reference bite frame by detecting the correspondence between the model for the teeth of the lower jaw and the reference bite image, and determining a second transform information between the generated model for the teeth of the lower jaw and the reference bite frame based on the detected correspondence.

12. The system of claim 9, wherein the first process module is configured for:
aligning the model for the teeth of the upper jaw with the reference bite frame by:
aligning one of the three dimensional surfaces for the teeth of the upper jaw and the reference bite frame to determine upper transform information between said one of the three dimensional surfaces for the teeth of the upper jaw and the reference bite frame,
calculating a first transform information between the model for the teeth of the upper jaw and the reference bite frame based on the upper transform information and relationship between the model for the teeth of the upper jaw and said one of the three dimensional surfaces for the teeth of the upper jaw; and
aligning the model for the teeth of the lower jaw with the reference bite frame by:
aligning one of the three dimension surf aces for the teeth of the lower jaw and the reference bite frame to determine lower transform information between said one of the three dimensional surfaces for the teeth of the lower jaw and the reference bite frame,
calculating a second transform information between the model for the teeth of the lower jaw and the reference bite frame based on the lower transform information and relationship between the model for the teeth of the lower jaw and said one of the three dimension surfaces for the teeth of the lower jaw.

13. The system of claim 11, wherein the second process module is configured for aligning the model for the teeth of the upper jaw with the model for the teeth of the lower jaw based on the first and second transform information.
